(19) United States
(12) Patent Application Publication
(10) Pub. No.: US 2008/0083008 A1
(43) Pub. Date: Apr. 3, 2008

(54) BROADCASTING RECEIVING APPARATUS AND CONTROL METHOD THEREOF

(75) Inventor: Kyung-hwan LEE, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/772,294

(22) Filed: Jul. 2, 2007

(30) Foreign Application Priority Data
Sep. 29, 2006 (KR) 10-2006-0096255

(51) Int. Cl. H04N 7/16

(52) U.S. Cl. 725/140

(57) ABSTRACT

A broadcasting receiving apparatus and a control method thereof are provided. The broadcasting receiving apparatus comprises a signal receiver which receives a broadcasting signal; a demultiplexer which extracts predetermined additional information from the broadcasting signal; a storage part which stores area setting information corresponding to area information of a reception area; a setter which performs a basic setting operation to process the broadcasting signal; and a controller which controls the setter to perform the basic setting operation based on the area setting information stored in the storage part, corresponding to the area information if the area information is included in the additional information of the broadcasting signal received through the signal receiver when power is supplied.

### CROSS-REFERENCE TO RELATED APPLICATIONS

This application claims priority from Korean Patent Application No. 10-2006-0096255, filed on Sep. 29, 2006, in the Korean Intellectual Property Office, the disclosure of which is incorporated herein by reference.

### BACKGROUND OF THE INVENTION

1. Field of the Invention

Apparatuses and methods consistent with the present invention relate to a broadcasting receiving apparatus and a control method thereof, and more particularly, to a broadcasting receiving apparatus which receives a broadcasting signal having additional information, and a control method thereof

2. Description of the Related Art

In broadcasting receiving apparatuses such as a television (TV) or a set-top box, basic information including an audio language, an on screen display (OSD) language, channel scan and time according to reception area is set at the initial set-up stage. Thus, a user should set respective functions from menus for setting the basic information after supplying power to the broadcasting receiving apparatuses.

A related art broadcasting receiving apparatus requires a user to select many options to set such basic information, thereby causing inconvenience.

Further, in the related art broadcasting receiving apparatus, a target country is designated at the time of production and the OSD menus are also set according to language and time of the target country. Thus, when the target country is changed to another country which uses different language and time, the language of the preset OSD menu should be also changed at the time of sales at the latest. Otherwise, a user should change the language from the OSD menus using corresponding language by himself/herself.

### SUMMARY OF THE INVENTION

The present invention provides a broadcasting receiving apparatus which automatically sets country, language and time corresponding to the reception area by using an area code included in a broadcasting signal received when power is initially supplied, and a control method thereof.

According to an aspect of the present invention, there is provided a broadcasting receiving apparatus, comprising a signal receiver which receives a broadcasting signal; a demultiplexer which extracts predetermined additional information from the broadcasting signal; a storage part which stores area setting information corresponding to area information of a reception area; a setter which performs a basic setting operation to process the broadcasting signal; and a controller which controls the setter to perform the basic setting operation based on the area setting information stored in the storage part, corresponding to the area information if the area information is included in the additional information of the broadcasting signal received through the signal receiver when power is supplied.

The controller may determine whether the area information is included in the additional information of the received broadcasting signal if power is supplied and an automatic setting function is selected.

The area setting information may comprise at least one of a language font corresponding to a language of the reception area, time, a frequency band and channel information.

The broadcasting receiving apparatus may further comprise a user selection part, wherein the controller controls the setter to perform the basic setting operation based on a setting command input through the user selection part if the automatic setting function is not selected.

The controller may control the setter to perform the basic setting operation based on the setting command input through the user selection part if the area information is not included in the additional information.

According to another aspect of the present invention, there is provided a method of controlling a broadcasting receiving apparatus, comprising receiving a broadcasting signal when power is supplied; extracting additional information from the received broadcasting signal; determining whether area information is included in the extracted additional information; and performing a basic setting operation to process the broadcasting signal based on area setting information corresponding to the area information, the area setting information being stored corresponding to the area information of the reception area.

The method may further comprise determining whether an automatic setting function is selected if power is supplied.

The area setting information may comprise at least one of a language font corresponding to a language of the reception area, time, a frequency band and channel information.

The method may further comprise performing the basic setting operation based on a setting command from a user if the automatic setting function is not selected.

The method may further comprise performing the basic setting operation based on the setting command from a user if the area information is not included in the additional information.

### BRIEF DESCRIPTION OF THE DRAWINGS

The above and/or other aspects of the present invention will become apparent and more readily appreciated from the following description of the exemplary embodiments, taken in conjunction with the accompanying drawings of which:

FIG. 1 is a control block diagram of a broadcasting receiving apparatus according to an exemplary embodiment of the present invention;

FIG. 2 is a control flowchart of a broadcasting receiving apparatus according to an exemplary embodiment of the present invention; and

FIG. 3 is a control flowchart of a broadcasting receiving apparatus according to another exemplary embodiment of the present invention.

### DETAILED DESCRIPTION OF EXEMPLARY EMBODIMENTS

Hereinafter, exemplary embodiments of the present invention will be described with reference to accompanying drawings, wherein like numerals refer to like elements and repetitive descriptions will be avoided as necessary.

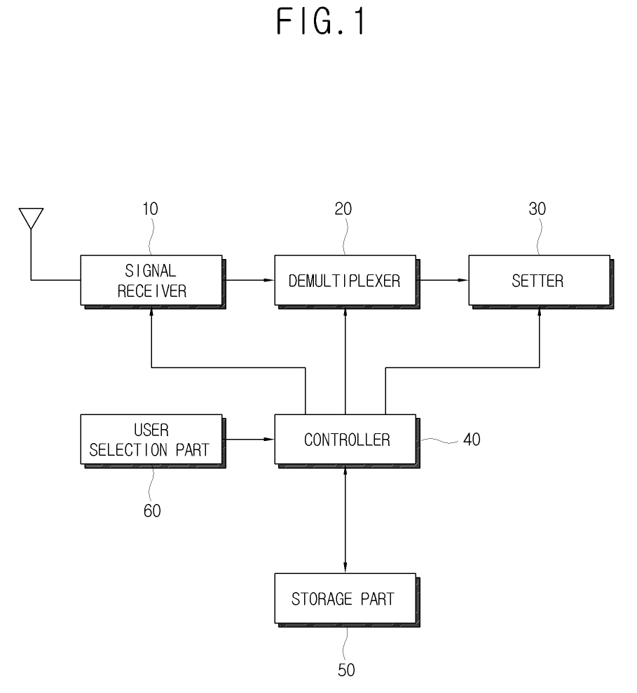

The present invention is applicable to a set-top box receiving digital broadcasting or a digital broadcasting receiver such as a digital TV. As shown in FIG. 1, a broadcasting receiving apparatus according to an exemplary embodiment of the present invention comprises a signal receiver 10, a demultiplexer 20, a setter 30, a storage part 50 and a controller 40 which controls the foregoing elements.

The signal receiver 10 receives a broadcasting signal from the outside and may be realized by a tuner. The signal receiver 10 tunes a channel selected by a user according to a control of the controller 40 and receives a broadcasting signal according thereto.

The broadcasting signal according to the present invention comprises a video signal, an audio signal and additional information and may be encoded and received as a transport stream in the type of Moving Picture Experts Group 2 (MPEG-2).

Here, the additional information may comprise Service Information (SI) of the Transport Stream.

The demultiplexer 20 demultiplexes a stream of a digital broadcasting signal received through the broadcasting channel according to the control of the controller 40 and divides it into audio, video and data streams to be output. The demultiplexer 20 parses the data stream to obtain the Service Information.

The setter 30 performs basic setting operation of the broadcasting receiving apparatus according to the control of the controller 40. The setter 30 may comprise a timer, an OSD generator and a memory.

The storage part 50 stores a plurality of basic settings corresponding to area information when the broadcasting receiving apparatus is manufactured. For example, the area information comprises a country code included in the additional information of the broadcasting signal. The storage part 50 may store information such as a language, time and a frequency band according to the country code.

For example, the storage part 50 stores font data corresponding to one or more languages depending on the country code. The storage part 50 sends the font data corresponding to the language set by the setter 30 to a signal processor (not shown).

The controller 40 uses a parsing result of the transport stream (TS) extracted by the demultiplexer 20 to determine where the broadcasting receiving apparatus according to the present invention is installed.

For example, the controller 40 controls the signal receiver 10 to scan a receivable channel when power is initially supplied to the broadcasting receiving apparatus, and may parse the TS from the broadcasting signal of the initially-received channel to determine the SI of the additional information.

If the SI contains the country code, the controller 40 controls the setter 30 to perform the basic setting operation corresponding to area setting information of the country code stored in the storage part 50.

That is, the controller 40 controls the setter 30 to set a language to the language of the reception area of the broadcasting signal according to the derived area code based on the settings stored in the storage part 50, to automatically scan the received plurality of broadcasting channels and to perform an automatic time setting operation.

When the setter 30 starts performing an operation to provide the OSD data, particularly the OSD menu, the controller 40 determines whether the setting language exists based on a value of the stored country code.

For example, if the broadcasting receiving apparatus according to the present invention composes a terrestrial digital TV which is used in Europe, the controller 40 checks the country code in the SI derived from an initially-tuned channel among channels with UHF 8 MHz band. For example, if the country code is 100, French country code, the controller 40 selects the area setting information corresponding to the country code 100.

The storage part 50 may store French, the language corresponding to the country code 100, and the currently-used frequency band.

If there exists the font data corresponding to French, the determined language, the controller 40 controls the setter 30 to set the font data of French as a basic language and stores it in a memory (not shown). An OSD generator (not shown) generates OSD data by using the font data stored in the memory.

The controller 40 extracts time data table (TDT) information corresponding to the country code among the derived service information, and controls the setter 30 to perform a predetermined automatic time setting operation to automatically set the current time of the timer.

The controller 40 may automatically tune a channel according to a channel frequency corresponding to the country code, and control the setter 30 to store a tuned channel list in the channel memory.

The broadcasting receiving apparatus according to the present invention may further comprise a user selection part 60.

The user selection part 60 is provided to select an automatic setting function and the basic settings. The user selection part 60 may comprise a remote controller or a button provided in the broadcasting receiving apparatus.

If the country code does not exist in the SI extracted through the demultiplexer 20, the controller 40 controls the setter 30 to perform the basic setting operation upon receipt of a user's basic setting selection command through the user selection part 60.

Even if the automatic setting function is not selected so as not to perform the basic setting operation automatically at the initial power-on stage, the controller 40 may receive the basic setting selection command through the user selection part 60.

The controller 40 may control the OSD generator to generate and output the selection menu to receive the basic setting selection command from the user. Here, the OSD generator displays the selection menu with a default language set when the broadcasting receiving apparatus is manufactured or released to the market.

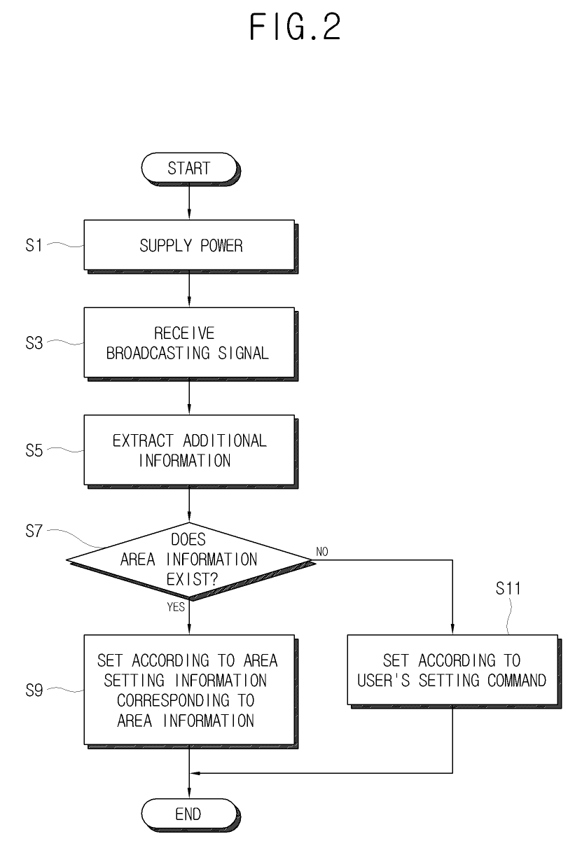

Hereinafter, an operation of the broadcasting receiving apparatus according to the present invention will be described in detail with reference to FIG. 2.

As shown in FIG. 2, when power is supplied (SI), the controller 40 tunes the channel through the tuner of the signal receiver 10 to receive the broadcasting signal (S3).

When the broadcasting signal is received through the initially-tuned channel, the controller 40 extracts the additional information from the received broadcasting signal (S5), and determines whether the extracted additional information contains the area information corresponding to the reception area of the broadcasting signal (S7).

If the area information is included in the additional information, the controller 40 controls the setter 30 to perform the basic setting operation according to the area setting information corresponding to the area information (S9).

If the area information is the country code, the area setting information may comprise a language, time, a frequency band, channel information, or other information known in the art corresponding to the country code.

If the area information is not included in the additional information at operation S7, the controller 40 controls the setter 30 to perform the setting operation after receiving the language, time, the frequency band and the channel information upon receipt of a user's setting command according to the general setting method (S11).

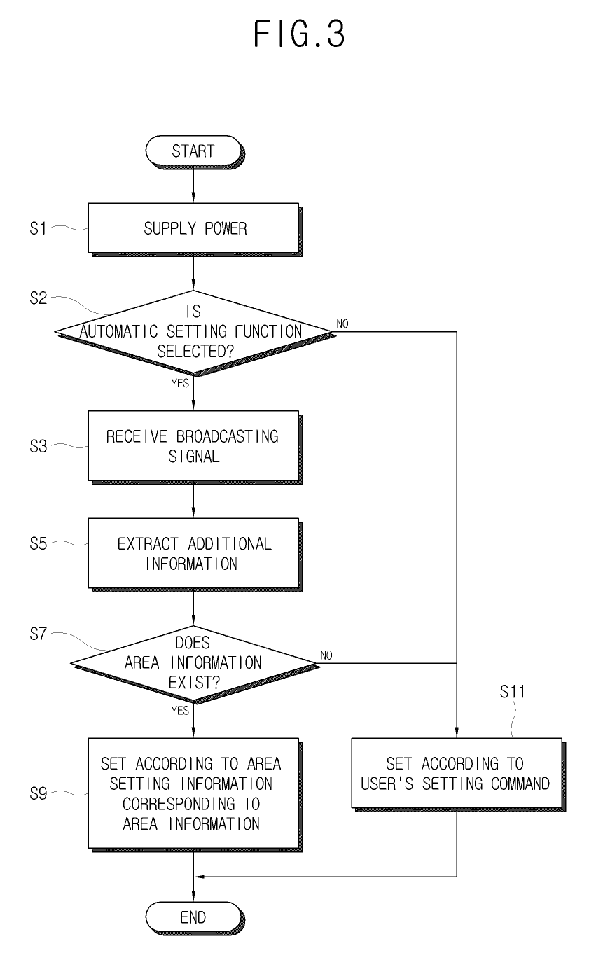

FIG. 3 illustrates operation of a broadcasting receiving apparatus according to another exemplary embodiment of the present information.

When power is initially supplied to the broadcasting receiving apparatus (S1), a controller 40 determines whether an automatic setting function is selected (S2). If it is determined that the automatic setting function is selected, the controller 40 tunes a channel through a tuner of a signal receiver 10 to receive a broadcasting signal (S3).

If the broadcasting signal is received through the initially-tuned channel, the controller 40 extracts additional information from the received broadcasting signal (S5), and determines whether area information corresponding to a reception area of the broadcasting signal exist in the extracted additional information (S7).

If the area information is included in the additional information, the controller 40 controls the setter 30 to perform the basic setting operation according to the area setting information corresponding to the area information (S9).

If it is determined at operation S2 that the automatic setting function is not selected, the controller 40 controls the setter 30 to perform the basic setting operation according to a user's command (S11).

The broadcasting receiving apparatus according to the present invention may automatically perform the basic setting operation according to the country code of the reception area when powered on initially.

The basic setting may be automatically changed according to the country code of the received SI in places where the area information such as the country code is different.

As described above, the present invention provides a broadcasting receiving apparatus which automatically sets a country, a language, time, other information known in the art corresponding to a reception area by using area information included in a broadcasting signal received when power is initially supplied, and a control method thereof.

Thus, a user may minimize menu selections and perform a basic setting operation of the broadcasting receiving apparatus without difficulty.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A broadcasting receiving apparatus comprising:
a signal receiver which receives a broadcasting signal;
a demultiplexer which extracts additional information from the broadcasting signal;
a storage part which stores area setting information corresponding to area information of a reception area;
a setter which performs a basic setting operation to process the broadcasting signal; and
a controller which controls the setter to perform the basic setting operation based on the area setting information stored in the storage part, corresponding to the area information, if the area information is included in the additional information of the broadcasting signal received through the signal receiver when power is supplied.

2. The broadcasting receiving apparatus according to claim 1, wherein the controller determines whether the area information is included in the additional information of the received broadcasting signal if power is supplied and an automatic setting function is selected.

3. The broadcasting receiving apparatus according to claim 1, wherein the area setting information comprises at least one of a language font corresponding to a language of the reception area, time, a frequency band and channel information.

4. The broadcasting receiving apparatus according to claim 1, further comprising a user selection part, wherein
the controller controls the setter to perform the basic setting operation based on a setting command input through the user selection part if the automatic setting function is not selected.

5. The broadcasting receiving apparatus according to claim 4, wherein the controller controls the setter to perform the basic setting operation based on the setting command input through the user selection part if the area information is not included in the additional information.

6. A method of controlling a broadcasting receiving apparatus, the method comprising:
receiving a broadcasting signal when power is supplied;
extracting additional information from the received broadcasting signal;
determining whether area information is included in the extracted additional information; and
performing a basic setting operation to process the broadcasting signal based on area setting information corresponding to the area information, the area setting information being stored corresponding to the area information of the reception area.

7. The method according to claim 6, further comprising determining whether an automatic setting function is selected if power is supplied.

8. The method according to claim 6, wherein the area setting information comprises at least one of a language font corresponding to a language of the reception area, time, a frequency band and channel information.

9. The method according to claim 6, further comprising performing the basic setting operation based on a setting command from a user if the automatic setting function is not selected.

10. The method according to claim 9, further comprising performing the basic setting operation based on the setting command from a user if the area information is not included in the additional information.
